(19) United States
(12) Patent Application Publication
(10) Pub. No.: US 2011/0180548 A1
(43) Pub. Date: Jul. 28, 2011

(54) SPECIALLY-FORMED PRESSURE VESSEL BODY

(75) Inventors: Lenny Kuslitsky, Houston, TX (US); Bruce E. Urband, Houston, TX (US); Harrell D. Lusk, Conroe, TX (US); Andrew Stephen Ayer, Spring, TX (US); Kaushik Mallick, Thornton, CO (US)

(73) Assignee: PASCALLOY SYSTEMS, INC.

(21) Appl. No.: 12/694,091

(22) Filed: Jan. 26, 2010

(51) Int. Cl. F17C 1/00; B21D 37/16

(52) U.S. Cl. 220/581; 72/342.1

(57) ABSTRACT

A pressure vessel may be formed from a thermally processed metal tube. The thermally processed metal tube may be seamless with a large length to diameter ratio. End portions of the thermally processed metal tube may be formed at a first temperature below the lower critical temperature by a load less than about the ultimate stress of the metal. After forming, the end portion may be thermally reconditioned at a second temperature below the lower critical temperature to relieve stress and approach similar material properties as the thermally processed metal tube.

### BACKGROUND

1. Field of the Disclosure

The present disclosure relates to pressure vessels and pressure vessel manufacturing and more particularly, to pressure vessel bodies formed using metal tubes and the methods used to form them.

2. Description of the Related Art

Cylindrical pressure vessel formation traditionally begins with an as-rolled or “green” metal tube, such as, for example, a steel, aluminum, titanium, nickel-based alloy, or other metal or metal alloy tube. The “green” metal tube, as the metal tube is called when formed at the pipe mill, is relatively soft and malleable and is commensurately suitable for mechanical processing. In the traditional method, the “green” tube is typically heated to a hot forming temperature, mechanically deformed such that the ends of the metal tube are constricted to a smaller diameter, and then quenched and tempered to form a pressure vessel body. This tempering step may impart a desired material strength to the entire pressure vessel body, satisfying required material properties for the pressure vessel. The pressure vessel body is subsequently sealed on the end(s) to produce a pressure vessel.

Certain applications require cylindrical pressure vessels of lengths that exceed the lengths that can be handled by common heat-treating equipment. As the length to diameter ratio of the metal tube increases, usage of specialized equipment and/or other scarce resources may be involved in the forming and thermal processing, which may require large capital expenditures, and result in high operational costs, long processing times, increased risk, and increased energy consumption. For longer pressure vessel bodies, subsequent thermal processing step(s) may thus be especially disadvantageous with respect to a number of key economic aspects, which may negatively impact the commercialization of pressure vessels so formed.

It follows that there is a need for an economical method and system for forming a metal tube into a pressure vessel body that avoids thermal processing of the entire pressure vessel body length.

### BRIEF DESCRIPTION OF THE DRAWINGS

FIGS. 1A-1F are cross-sectional diagrams of selected elements of a method consistent with the present invention using a linear forming tool;

FIG. 2 is a diagram of selected elements of an embodiment of a rotary forming tool;

FIG. 3 is a diagram of selected elements of an embodiment of an iron-carbon equilibrium phase diagram; and

FIG. 4 is a block diagram in flow chart form of selected elements of an embodiment of a method of forming a pressure vessel body.

### DESCRIPTION OF THE EMBODIMENT(S)

In one aspect, a disclosed method for forming a pressure vessel body includes obtaining a thermally processed metal tube. The metal tube has an end portion. A pressure vessel body end portion is formed from the end portion of the thermally processed metal tube at a first temperature below the lower critical temperature, wherein the end portion is plastically deformed by a load greater than the yield strength of the metal tube. The pressure vessel body end portion is thermally reconditioned at a temperature below the lower critical temperature to form the pressure vessel body.

In another aspect, a pressure vessel body is formed from an thermally processed metal tube. The thermally processed metal tube has two end sections on both sides of a middle section of the thermally processed metal tube. The end sections have been manufactured by a process that includes forming the end section at a first temperature below the lower critical temperature, wherein the end section is plastically deformed by a load less than about an ultimate stress of the metal. The process further includes after said forming, subjecting a length of the end portion to thermal reconditioning by heating to a second temperature below the lower critical temperature, wherein the reconditioned length corresponds to less than about three times an outer diameter of the steel tube. As a result of the thermal reconditioning, a material property of the reconditioned length is made more similar to a corresponding material property of the middle section.

In still another aspect, a disclosed method for forming a pressure vessel body includes obtaining a thermally processed metal tube. The thermally processed metal tube has an end portion and a diameter, where the end portion is less than 1.5 times the diameter. The pressure vessel body end portion is formed from the end portion of the thermally processed metal tube at a first temperature less than the tempering temperature of the thermally processed metal tube, wherein the end portion is plastically deformed by a load greater than the yield strength of the metal tube. The pressure vessel body is thermally reconditioned at a thermal reconditioning temperature. The thermally reconditioning temperature is below the tempering temperature of the thermally processed metal tube to form the pressure vessel body.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. A reference numeral with a letter may similarly refer to an instance of an element, while the reference numeral alone may refer to the element generically or collectively. Thus, for example, widget 12-1 (or 12a) refers to an instance of a widget class, which may be referred to collectively as widgets 12 and any one of which may be referred to generically as a widget 12.

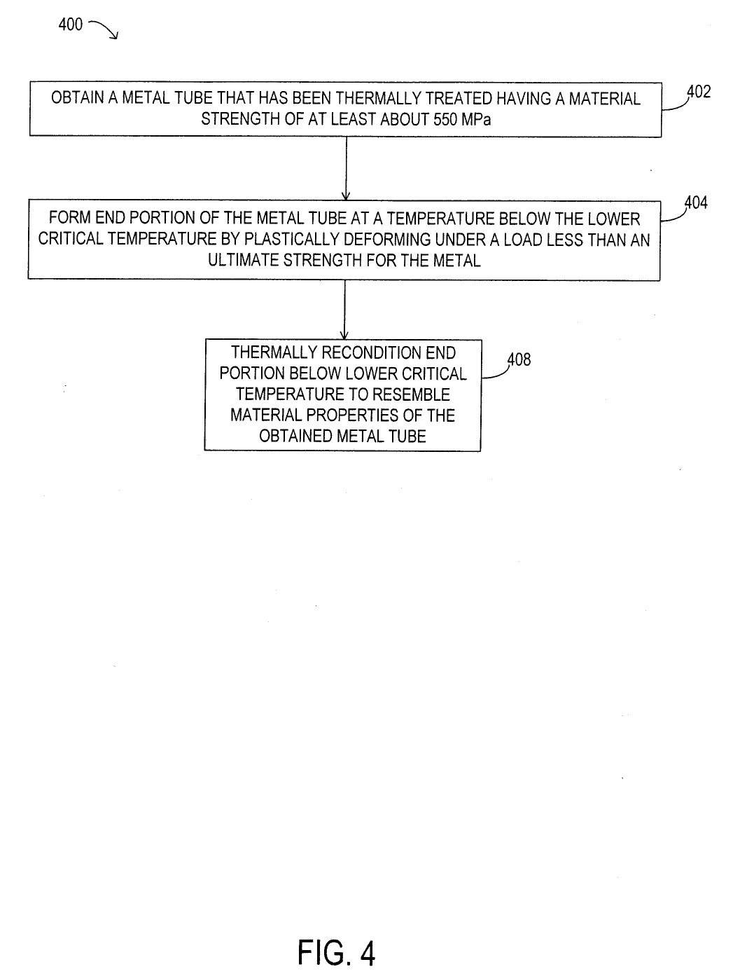

Turning to FIG. 4, a block diagram of selected elements of an embodiment of method 400 of forming a pressure vessel body is illustrated in flow chart form. Method 400 may be applicable to a wide range of lengths and diameters of metal tube for forming pressure vessel bodies therewith. It is noted that in certain embodiments, operations in method 400 may be rearranged or omitted, as desired.

In method 400, a metal tube that has been thermally processed to form a thermally processed metal tube having a material yield strength of sufficient for forming a cylindrical pressure vessel may be obtained (operation 402). The thermally processed metal tube may be comprised of such materials as steel, aluminum, titanium, nickel-based alloys, or other metal or metal alloy tube. Typically, for steel, the yield strength of the thermally processed metal tube is at least about 480 MPa. The thermal processing may have been performed along an entire length of the metal tube during manufacture, such that the thermally processed metal tube has substantially uniform material properties acceptable for cylindrical pressure vessel use. The thermally processed metal tube may be a seamless, centrifically-cast or longitudinally-welded metal tube. The thermally processed metal tube may have a substantially uniform inner and/or outer diameter. The thermally processed metal tube may also have a substantially uniform wall thickness. The thermally processed metal tube has at least two end portions. In certain embodiments, the thermally processed metal tube may have different geometries and include more than two end sections.

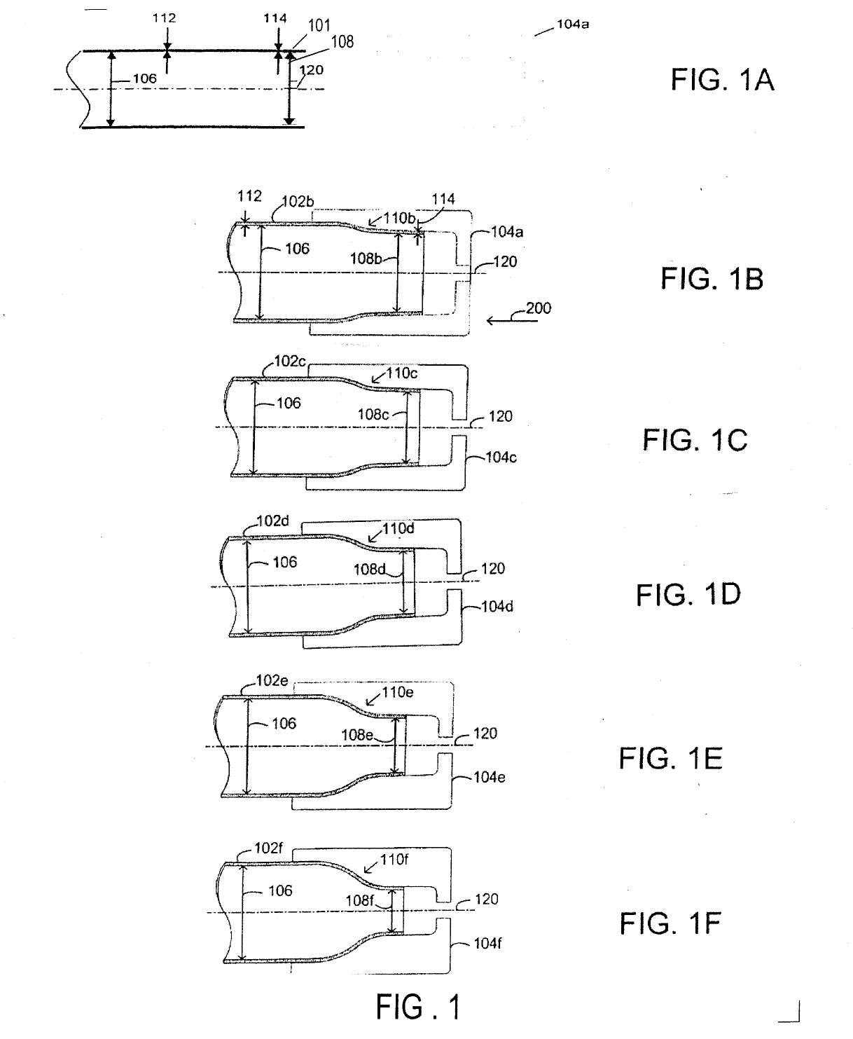

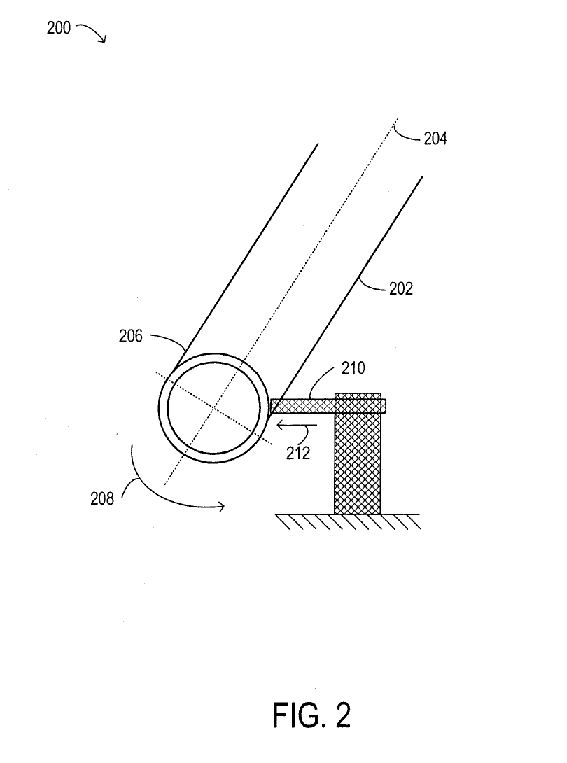

In certain embodiments, a formed end portion of a pressure vessel body may be formed by the deformation of an end portion of the thermally processed metal tube at a temperature below the lower critical temperature of the metal. In certain other embodiments, a formed end portion of pressure vessel body may be formed by the deformation of an end portion of the thermally processed metal tube at a temperature below the tempering temperature of the thermally processed metal tube. The formed end portion is typically less than about five times the diameter of the thermally processed metal tube, and more typically less than three times, and most typically less than 1.5 times the diameter of the thermally processed metal tube. The formed end portion of a pressure vessel body is formed by plastically deforming the end portion of the thermally processed metal tube under a load greater than the yield point, but less than the ultimate strength for the metal (operation 404). The forming of the formed end portion may involve linear forming (see FIGS. 1A through 1F), a process used to change the shape of the thermally processed metal tube longitudinally along the long axis of the tube or rotary forming (see FIG. 2), a combination of linear forming and rotary forming, or other conventional methods for forming metals and metal alloys. The forming process may be used to change the shape of the thermally processed metal tube radially about the centerline of the thermally processed metal tube, at a temperature below the lower critical temperature or tempering temperature.

In certain embodiments, the forming is performed at about ambient temperature (i.e., a cold forming temperature). In other embodiments, the forming is performed at a temperature above ambient. For embodiments using steel for the thermally processed metal tube, this temperature may typically be between about 400° C. and the lower critical temperature (i.e., a warm forming temperature). In other embodiments, the forming is performed below the tempering temperature of the thermally processed metal tube. For embodiments using steel for the thermally processed metal tube, the forming may be performed at a temperature between about 400° C. and the tempering temperature. As noted previously, a forming temperature may refer to a temperature of a work piece, a forming tool, and/or a forming environment.

In certain embodiments, the forming process of operation 404 may consist of a number of sub-steps. As discussed above, the forming step typically includes a deformation sub-step, wherein the end portion of the metal tube is subjected to mechanical deformation in order to form the formed end portion. In certain embodiments, the end portion of the metal tube may be subjected to heating to a desired warm forming temperature for a single instance or multiple instances. In certain other embodiments, the forming step may include cooling the temperature of the end portion of the metal tube to a desired temperature at or above ambient temperature for a single instance or multiple instances after heating to a desired warm forming temperature, the cooling step accomplished by such methods as forced air, stagnant air, or a liquid media bath. The forming process of operation 404 may also consist of a number of hold steps, where the thermally processed metal tube is maintained at a given state for a desired period of time. As would be recognized by one of ordinary skill in the art, the present invention is not limited to any particular order or number of the sub-steps, i.e., a heating step may be followed by a cooling step by a deformation step, or a deformation step by a heating step by two cooling steps, or any other combination, or a heating step by a deformation step.

The loading of the end portion of the thermally processed metal tube during forming may be limited to within a fraction of the ultimate strength of the metal in order to prevent tearing, i.e., introducing unacceptable imperfections into the metal of the metal tube. In certain embodiments, the load may be dependent on the forming temperature. The forming in operation 404 may substantially maintain a predetermined tube thickness of the end portion of the thermally processed metal tube. The forming operation in operation 404 may form a reduced diameter neck terminating the formed end portion, with a substantially reduced outer diameter less than the original outer diameter of the thermally processed metal tube.

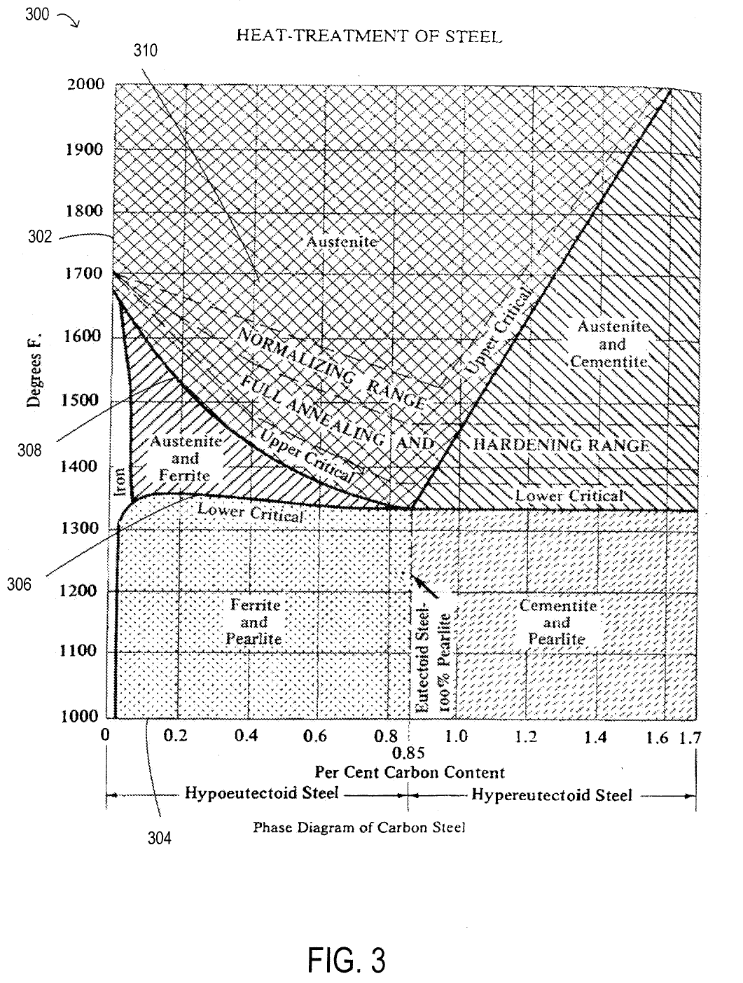

Method 400 may then continue with thermally reconditioning the formed end portion below the lower critical temperature of the metal to resemble the mechanical properties of the thermally processed metal tube (operation 408). Alternatively, the thermally reconditioning step may be performed at a temperature below the tempering temperature. During operation 404, the mechanical properties of the formed end portion may be altered. In certain embodiments, a reduction in toughness and an increase in hardness or strength of deformed portions of the formed end portion due to strain hardening may occur. The thermal reconditioning of operation 408 may provide stress relief after prior forming from operation 404, which may have resulted in a cumulative strain hardening that has increased material strength or reduced toughness. It is noted that the thermal reconditioning from operation 408 may be performed at a temperature below a lower critical temperature (see also FIG. 3) for the metal of the thermally processed metal tube. Alternatively, the thermal reconditioning from operation 408 may be performed at a temperature below the tempering temperature of the thermally processed metal tube. The thermal reconditioning of operation 408 may further involve controlling of various heating and/or cooling parameters. In one embodiment, a desired heating rate to a desired temperature is controlled during thermal reconditioning of operation 408. Once the desired temperature is attained, a desired hold time at the desired temperature may be controlled. After the desired hold time has elapsed, a desired cooling rate may be controlled. In different embodiments, the thermal reconditioning may involve cyclical application of individual thermal reconditioning steps involving heating, hold time, and cooling, as desired.

The thermal reconditioning of operation 408 may cause the material properties of the formed end portion of the thermally processed metal tube to approach the mechanical properties of a middle section of metal tube. It is particularly noted that, in certain embodiments, the thermal reconditioning of operation 408 may be performed on a length of pressure vessel body end portion of the metal tube, less than or equal to about three (3) times an outer diameter of the metal tube. Various numbers of tube forming and thermal reconditioning steps may be implemented in various embodiments.

The deformation sub-step of the forming operation 404 may be accomplished by a number of commonly used metal deformation method, such as for instance, linear or rotary forming deformation methods.

Method 400 may be used to produce pressure vessel bodies for particular specialty services requiring such properties as improved corrosion resistance, lessened embrittlement, and reduced environmental cracking. An example of such specialty service is sour gas service where resistance to sulfide stress cracking may be important. As one of ordinary skill in the art will recognize with the benefit of this disclosure, by altering the metal or metal alloy used in the green tube used to manufacture the thermally processed metal tube, altering the conditions used to manufacture the thermally processed metal tube and/or selecting the conditions for the thermal reconditioning step 408, such as the temperature for heating and/or cooling, or the time for a hold time.

FIGS. 1A through 1F are block diagrams illustrating the process of linear forming using linear forming tool(s) 104(a-f) for forming thermally processed metal tube 101 to pressure vessel body 102(a-f). As used herein, linear forming tool 104 may be generally referred to as a “tool”, while pressure vessel body 102(a-f) may generally be referred to as a “part” or a “work piece.” It is noted that elements depicted in FIGS. 1A through 1F are not specifically drawn to any particular scale, but are representative for a variety of sizes, diameters, thicknesses, and lengths that describe various embodiments. The particular geometries and relative dimensions depicted in FIGS. 1A through 1F are thus an illustrative example of a series of five (5) successive mechanical processing operations to form a pressure vessel body end portion 110(a-f), including neck at 108(b-f) of pressure vessel body 102(a-f), as will be described in detail below.

As described above, in some embodiments, a different number of successive deformation sub-steps of forming operation 404 may be used with different heating, cooling, and holding sub-steps using correspondingly shaped linear forming tools 104 for the forming operation 404 to achieve desired results. It is further noted that, although the examples presented herein are described using steel as the primary pressure vessel body material, in given embodiments, other materials, and in particular other metals and alloys, may be used in place of steel for the work piece material.

In FIGS. 1A through 1F, centerline 120 represents a cylindrical line of symmetry, such that the depicted diagrams are cross-sections of substantially cylindrical structures, or structures having cylindrical symmetry. Thermally processed metal tube 101 may be a seamless, centrifically-cast or longitudinally-welded metal tube with a substantially uniform outer diameter, substantially uniform thickness, and substantially uniform material properties.

In various embodiments, thermally processed metal tube 101 may represent a part that has been subject to thermal treatment along an entire length during manufacture and has been obtained with a correspondingly high material strength (i.e., a yield strength greater than about 480 MPa) for further processing according to the methods described herein. In other words, thermally processed metal tube 101 may be obtained with material properties corresponding to material standards for pressure vessels, prior to processing pressure vessel body end portions using linear forming tool 104. As used herein, “obtain” or “obtaining” or “obtained” refers to receiving, or being received, from a previous process, from a vendor, from an inventory or storage, and/or from a manufacturer. The thermal treatment that thermally processed metal tube 102 has been subject to may have included normalization, quenching and tempering, or various combinations thereof.

FIG. 1A depicts thermally processed metal tube 101. Thermally processed metal tube 101 has thickness wall thickness 112, end portion wall thickness 114, and outer diameter 106. FIG. 1A further depicts the diameter of neck portion 108a. Typically, the diameter of neck portion 108a and outer diameter 106 are substantially identical, as FIG. 1A depicts thermally processed metal tube 101 prior to linear forming. FIG. 1A further depicts linear forming tool 104a.

As shown in FIG. 1B, pressure vessel body end portion 110b of metal pressure vessel body 102b may be formed by insertion into linear forming tool 104a, which may also be generally referred to as a “pressure vessel body linear forming” operation. In certain embodiments, pressure vessel body 102b may be fixed during the pressure vessel body linear forming operation, while linear forming tool 104a is forced under load (i.e., by pressing) in direction 200 substantially formed pressure vessel body end portion 110b of pressure vessel body 102b. Prior to linear forming, pressure vessel body end portion 110b of pressure body 102b, or linear forming tool 104a, may be coated with a lubricant (not shown in FIGS. 1A through 1F) to reduce surface friction during the tube forming operation. Since depth of penetration during linear forming may contribute to a final shape, and/or to a desired degree of deformation, pressure vessel body end portion 110b of pressure vessel body 102b may be formed by restricting (or controlling) a depth of penetration of pressure vessel body end portion 110b into linear forming tool 104a. In certain embodiments, a rate of penetration of pressure vessel body 110a into linear forming tool 104a may be restricted (or controlled) to attain a desired shape and/or a desired degree of deformation. It is noted that operating parameters of the linear forming operation, such as penetration depth and rate of penetration during linear forming, may be determined in conjunction with an applied load and/or a forming temperature.

Depending on a profile, or contour, of linear forming tool 104a, pressure vessel body end portion 110b of metal pressure vessel body 102b may be subject to a certain controlled amount of plastic deformation and/or loading during a linear forming operation. The loading may result in a material stress in metal pressure vessel body end portion 110b that is less than about the ultimate stress of the metal. It is noted that linear forming tool 104a may be suitable for forming metal pressure vessel body end portion 110b at a temperature below a lower critical temperature, (see also FIG. 3), or a lower tempering temperature. In certain embodiments, linear forming tool 104a may be used at relatively low temperature, such as ambient temperature. In certain embodiments, a temperature of pressure vessel body end portion 110b and a temperature of linear forming tool 104a may be different and/or separately regulated. In still further embodiments, temperature regulation of an ambient environment may be applied.

It is further noted that during linear forming of pressure vessel body end portion 110b of pressure vessel body 102a by linear forming tool 104a, end portion wall thickness 114 of pressure vessel body end portion 110b may remain constant or may not be substantially reduced below a predetermined minimum wall thickness along sections of pressure vessel body end portion 110b that have been plastically deformed. In certain embodiments, end portion wall thickness 114 may be greater than wall thickness 112 for certain portions of pressure vessel body end portion 110(a-f).

In FIG. 1B, linear forming tool 104b may be configured to create pressure vessel body 102b having outer diameter 106, but with pressure vessel body end portion 110b of pressure vessel body having outer diameter 108a prior to forming. Linear forming tool 104b may be capable of forming pressure vessel body end portion 110b to the outer diameter of neck 108b, which is less than outer diameter of neck 108a, while maintaining end portion wall thickness 114 along end portion 110b at a value substantially equal to wall thickness 112 (see FIG. 1A). Outer diameter of neck 108b may be formed along a terminating portion of pressure vessel body end portion 110b having substantially constant diameter (i.e., parallel tube geometry).

Pressure vessel body end portion 110b is typically less than five times as long as outer diameter 106, more typically less than three times as long as outer diameter 106 and most typically less than 1.5 times as long as outer diameter 106.

In FIG. 1C, linear forming tool 104c may be configured to create pressure vessel body 102c having outer diameter 106, but with pressure vessel body end portion 110c of pressure vessel body 102c having outer diameter 108b prior to forming. Linear forming tool 104c may be capable of forming pressure vessel body end portion 110c to the outer diameter of neck 108c, which is less than outer diameter of neck 108b, while maintaining end portion wall thickness 114 along end portion 110c at a value substantially equal to wall thickness 112 (see FIG. 1A). Outer diameter of neck 108c may be formed along a terminating portion of pressure vessel body end portion 110c having substantially constant diameter (i.e., parallel tube geometry).

In FIG. 1D, linear forming tool 104d may be configured to create pressure vessel body 102d having outer diameter 106, but with pressure vessel body end portion 110d of pressure vessel body having outer diameter 108c prior to forming. Linear forming tool 104d may be capable of forming pressure vessel body end portion 110d to the outer diameter of neck 108d, which is less than outer diameter of neck 108c, while maintaining end portion wall thickness 114 along end portion 110d at a value substantially equal to wall thickness 112 (see FIG. 1A). Outer diameter of neck 108d may be formed along a terminating portion of pressure vessel body end portion 110d having substantially constant diameter (i.e., parallel tube geometry).

In FIG. 1E, linear forming tool 104e may be configured to create pressure vessel body 102e having outer diameter 106, but with pressure vessel body end portion 110e of pressure vessel body having outer diameter 108d prior to forming. Linear forming tool 104e may be capable of forming pressure vessel body end portion 110e to the outer diameter of neck 108e, which is less than outer diameter of neck 108d, while maintaining end portion wall thickness 114 along end portion 110e at a value substantially equal to wall thickness 112 (see FIG. 1A). Outer diameter of neck 108e may be formed along a terminating portion of pressure vessel body end portion 110e having substantially constant diameter (i.e., parallel tube geometry).

In FIG. 1F, linear forming tool 104f may be configured to create pressure vessel body 102f having outer diameter 106, but with pressure vessel body end portion 110f of pressure vessel body having outer diameter 108e prior to forming. Linear forming tool 104f may be capable of forming pressure vessel body end portion 110f to the outer diameter of neck 108f, which is less than outer diameter of neck 108e, while maintaining end portion wall thickness 114 along end portion 110f at a value substantially equal to wall thickness 112 (see FIG. 1A). Outer diameter of neck 108f may be formed along a terminating portion of pressure vessel body end portion 110b having substantially constant diameter (i.e., parallel tube geometry).

Thus, as a result of the five (5) successive linear forming operations shown in FIGS. 1A through 1F, pressure vessel body end portion 110 of pressure vessel body 102(a-f), initially created from thermally processed metal tube 102, may have been narrowed from outer diameter 106 to outer diameter of neck 108e, while end portion wall thickness 114 is maintained substantially equivalent to wall thickness 112. In other embodiments (not shown in FIGS. 1A-1F), other shapes or forms may be created by respective linear forming tools 104. For example, a generally hemispherical shape may be formed at pressure vessel body end portion 110 by a linear forming operation.

Each respective linear forming operation in FIGS. 1A through 1F may represent a mechanical processing of pressure vessel body end portion 110(a-f) pressure vessel body 102 (a-f). The mechanical processing may involve plastic deformation of pressure vessel body end portion 110 (a-f) of pressure vessel body 102(a-f) under an applied load, for example, as provided by a press (not shown in FIGS. 1A through 1F) configured to apply linear forming tool 104(a-f) to pressure vessel body end portion 110(a-f). Linear forming tool 104 (a-f) may be specially designed to restrict plastic deformation in a single linear forming operation such that a load experienced by pressure vessel body end portion 110 (a-f) of pressure vessel body 102(a-f) is less than about an ultimate stress for the metal (see also FIG. 3). For example, tool 104(a-f) may impart a maximum load of 1/10, ⅕, ⅓, ½, 9/10, or another proportion of the ultimate strength in a single forming operation. Application of a load to pressure vessel body end portion 110(a-f) during mechanical processing may thus induce a strain, or a strain field, in certain deformed areas of steel pressure vessel body. A strain field may include multiple strain components, such as yield strain, compressive strain, shear strain, or combinations thereof. Accordingly, individual linear forming tool 104a through 104f may be specially designed to collectively perform a series of successive tube forming operations for a given material of a given dimension, to achieve desired final properties of the work piece.

At the conclusion of a tube forming operation, as in FIGS. 1A through 1F, material properties of end portion 110f of thermally processed metal tube 101 may substantially match, or approach, material properties of thermally processed metal tube 101 when thermally processed metal tube 101 was obtained. The material properties of end portion 110f of thermally processed metal tube 101 may thus remain suitable for forming a pressure vessel during tube forming operations, as described above with respect to FIGS. 1A through 1F. The material properties may be given by at least one of: hardness, yield strength, yield strain, elastic modulus, residual stress, ultimate strength, toughness and corrosion resistance.

In an alternate embodiment to linear forming, a rotary forming operation (see FIG. 2) may be performed on pressure vessel body end portion 110 of thermally processed metal tube 101. It is particularly noted that one advantage of a forming operation (either linear forming or rotary forming) for pressure vessel body end portion 110 of pressure vessel body 102(a-f), is that an entire length of thermally processed metal tube 101 need not be subject to heat treatment, such as quenching and tempering, to achieve desired material properties. One important unique feature of the methods described herein is therefore an inherent applicability to various lengths and diameters of metal pressure vessel body 102(a-f). In fact, no substantial difference in operating expenses, infrastructure, and equipment may be involved in forming various length to diameter ratios of thermally processed metal tube 101 into pressure vessels, according to the methods described herein.

The methods described herein may be used to subsequently form pressure vessels body for storing different compressed gases and/or hydrocarbon fuels in a gaseous or liquid state, such as methane, butane, and propane, among others. The forming operations described herein may result in a pressure vessel body that complies with generally accepted standards for pressure vessels, such as International Organization for Standardization ISO 11120, or other commensurate or applicable standards, including national and international standards.

Referring now to FIG. 2, a diagram illustrating selected elements of an embodiment of rotary forming operation 200 is presented in schematic form. It is noted that FIG. 2 is illustrative and is not drawn to any particular scale or dimensional accuracy. In rotary forming operation 200, thermally processed metal tube 202 represents a cylindrical work piece having longitudinal axis 204, which may be mechanically fixed. Thermally processed metal tube 202 may be mounted in an apparatus (not shown in FIG. 2) configured to controllably rotate thermally processed metal tube 202 in angular direction 208 (or in a reverse angular direction). In other words, thermally processed metal tube 202 may be rotated about longitudinal axis 204 in a desired angular direction, such as angular direction 208, under control of angular displacement, angular velocity, angular acceleration, and/or angular force.

During rotation of thermally processed metal tube 202, for example, by mounting in a rotary turning machine (not shown in FIG. 2), rotary forming tool 210, which is shown fixed relative to rotating thermally processed metal tube 202, may be configured to mechanically deform protruding end portion 206 of thermally processed metal tube 102. The deformation by rotary forming tool 210 may be applied in direction 212, and may cause forming of end portion 206 of thermally processed metal tube 202, while maintaining a thickness of thermally processed metal tube 202. In various embodiments, rotary forming tool 210 may be configured for additional axes of motion (not shown in FIG. 2), such as along longitudinal axis 204 or about a vertical rotational axis perpendicular to longitudinal axis 204. The rotational speed of thermally processed metal tube 202 and the amount of deformation applied by the rotary forming tool, for example, may be precisely controlled. In certain embodiments, a number of rotary turns in angular direction 208 may be precisely controlled. As with the tube forming example described above with respect to FIGS. 1A through 1E, rotary forming may be performed at a temperature below A_{c1}, while a mechanical load applied to end portion 206 of thermally processed metal tube 202 may be precisely administered to remain below an ultimate stress of the metal during rotary forming. Similar to tube forming, thermal reconditioning steps may be performed after rotary forming operation for stress relief. Resulting material properties of end portion 206 of metal tube 202 may thus match, or be made similar to, the material properties of obtained metal tube 102. In certain embodiments of rotary forming, end portion 206 of thermally processed metal tube 202 may be formed into a generally hemispherical shape and/or a reduced diameter neck.

Turning now to FIG. 3, a diagram of selected elements of an embodiment of iron-carbon equilibrium phase diagram 300 is shown. Phase diagram 300 depicts equilibrium phases and their transition points for temperature axis 302 versus carbon composition axis 304. It is noted that additional alloys and metals (not shown in FIG. 3) may be present in steel and may alter content in phase diagram 300. In phase diagram 300, lower critical temperature 306 represents a temperature at which austenite begins to form, while upper critical temperature 308 represents a temperature above which substantially uniform austenite phase 310 occurs. Since phase diagram 300 represents equilibrium values, certain variations of temperature values during heating and cooling may be observed.

Austenite phase 310 may represent a composition and temperature region, from where thermally processed metal tube 101 may have been thermally treated. For example, thermally processed metal tube 101 may have been quenched from a temperature above upper critical temperature 308, which is a non-equilibrium operation. After quenching, tempering to below lower critical temperature 306 may have been included in the thermal treatment to achieve desired material properties of thermally processed metal tube 101.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for forming a pressure vessel body, comprising:
obtaining a thermally processed metal tube, the metal tube having an end portion and a diameter;
forming a pressure vessel body end portion from the end portion of the thermally processed metal tube at a first temperature less than the lower critical temperature, wherein the end portion is plastically deformed by a load greater than the yield strength of the metal tube; and
thermally reconditioning the pressure vessel body end portion at a thermal reconditioning temperature, the thermally reconditioning temperature below the lower critical temperature to form the pressure vessel body.

2. The method of claim 1, wherein the step of forming the pressure vessel body end portion further includes deforming the end portion of the thermally processed metal tube at a rate at which the metal does not tear.

3. The method of claim 2, wherein the step of forming the pressure vessel body end portion further includes heating the end portion of the thermally processed metal tube to the first temperature, the first temperature being above ambient temperature and below the lower critical temperature.

4. The method of claim 3, wherein the step of forming the pressure vessel body end portion further includes cooling the end portion of the thermally processed metal tube to a second temperature, the second temperature between the first temperature and ambient temperature.

5. The method of claim 1, wherein the first temperature is less than the tempering temperature of the thermally processed metal tube.

6. The method of claim 1, wherein the thermally reconditioning temperature is less than the tempering temperature of the thermally processed metal tube.

7. The method of claim 1, wherein the pressure vessel body has a yield strength of about the yield strength of the thermally processed metal tube.

8. The method of claim 1, wherein the length of the end portion is less than five times the diameter of the thermally processed metal tube.

9. The method of claim 8, wherein the length of the end portion is less than three times the diameter of the thermally processed metal tube.

10. The method of claim 1, wherein the length of the end portion is less than 1.5 times the diameter of the thermally processed metal tube.

11. The method of claim 1, wherein the thermally processed metal tube is a seamless tube.

12. The method of claim 1, wherein the first temperature is a cold forming temperature at about ambient temperature.

13. The method of claim 1, wherein the load depends on the first temperature.

14. The method of claim 1, wherein said forming substantially maintains a predetermined minimum tube thickness of the end portion.

15. The method of claim 1, wherein the step of forming further includes linear forming the end portion using a linear forming tool that substantially encloses the end portion.

16. The method of claim 1, wherein said forming includes rotary forming the end portion.

17. The method of claim 15, wherein the step of forming further includes rotary forming the end portion.

18. The method of claim 1, further comprising:
repeating said forming over a plurality of iterations, wherein the end portion is plastically deformed to a cumulative deformation substantially given by a sum of a deformation for each of the plurality of iterations.

19. The method of claim 1, wherein the thermal reconditioning includes controlling at least one of: a heating rate, a cooling rate, and a hold time at the second temperature.

20. The method of claim 19, wherein the thermal reconditioning causes a material property of the reconditioned length to approach a corresponding material property of the thermally processed metal tube.

21. The method of claim 18, wherein the material property is given by at least one of:
hardness, yield strength, yield strain, elastic modulus, residual stress, and ultimate strength.

22. A pressure vessel body formed from an thermally processed metal tube, comprising:
two end sections on both sides of a middle section of the thermally processed metal tube, wherein the end sections have been manufactured by a process comprising:
forming the end section at a first temperature below the lower critical temperature, wherein the end section is plastically deformed by a load less than about an ultimate stress of the metal; and
after said forming, subjecting a length of the end portion to thermal reconditioning by heating to a second temperature below the lower critical temperature, wherein the reconditioned length corresponds to less than about three times an outer diameter of the steel tube; and
wherein as a result of the thermal reconditioning, a material property of the reconditioned length is made more similar to a corresponding material property of the middle section.

23. The pressure vessel of claim 22, wherein the process further comprises:
repeating said forming over a plurality of iterations, wherein the end portion is plastically deformed to a cumulative strain substantially given by a sum of the strain for each of the plurality of iterations.

24. A method for forming a pressure vessel body, comprising:
obtaining a thermally processed metal tube, the metal tube having an end portion and a diameter, the end portion being less than 1.5 times the diameter;
forming a pressure vessel body end portion from the end portion of the thermally processed metal tube at a first temperature less than the tempering temperature of the thermally processed metal tube, wherein the end portion is plastically deformed by a load greater than the yield strength of the metal tube; and
thermally reconditioning the pressure vessel body end portion at a thermal reconditioning temperature, the thermally reconditioning temperature below the tempering temperature of the thermally processed metal tube to form the pressure vessel body.
